(19) United States
(12) Patent Application Publication
(10) Pub. No.: US 2007/0086348 A1
(43) Pub. Date: Apr. 19, 2007

(54) ATN network simulation for testing applications of terminal devices in civil aeronautics

(75) Inventor: Christophe Paletou, Castanet Tolosan (FR)

Correspondence Address: LOWE HAUPTMAN GILMAN & BERNER, LLP, 1700 DIAGNOSTIC ROAD, SUITE 300, ALEXANDRIA, VA, 22314, US

(73) Assignee: THALES, Neuilly Sur Seine (FR)

(21) Appl. No.: 11/171,409

(22) Filed: Jul. 1, 2005

(30) Foreign Application Priority Data
Jul. 2, 2004 (FR) 04 07385

(51) Int. Cl. H04L 12/26

(52) U.S. Cl. 370/241

(57) ABSTRACT

The present invention makes it possible to simulate an ATN network, doing so in order to test applications (31, 32, 33) of terminal devices. According to the invention, the simulation is carried out by means of a test machine (30) intended to be connected up to an IP network (40).

According to a preferred embodiment, the test machine comprises a driver (38) forming an interface between a network layer (37) and a BSD Socket interface (39).

In send mode, the driver encapsulates data originating from the top protocol layers (35, 36, 37), meeting the ATN specifications, in UDP datagrams, so as to be conveyed by way of the IP network (40). In receive mode, the driver de-encapsulates the data for sending to the top protocol layers.

### BACKGROUND OF THE INVENTION

The present invention relates to the ATN Aeronautical Telecommunications Network. The ATN network is intended to interlink the subnetworks of the various parties in aeronautics (air traffic control services, airlines, civil or private aircraft, weather services, airport services, etc.) so as to exchange data (control order, weather messages, flight parameters, position reports, passenger communications, etc.) in a reliable and secure manner.

The formats of the messages and of the telecommunications protocols are standardized by the International Civil Aviation Organization (ICAO). These formats rely on the OSI network architecture model (the acronym standing for “Open System Interconnection”). The OSI model is that of the ISO (International Standardization Organization).

The ATN network is not yet developed to date. However, the air traffic management systems and software currently under development will have to meet the requirements of the standards of the ATN. Industry must consequently make provision to qualify the new systems. This qualification may not be carried out on the existing devices, on the one hand because the ATN infrastructure is not yet developed to date, and on the other hand for obvious security reasons.

It is consequently necessary to develop systems for testing the new devices and software. For this purpose, a test system must make it possible to simulate the ATN network interfaces accessed by the device or the software to be tested.

### SUMMARY OF THE INVENTION

A subject of the invention is a method of simulating an ATN network intended for testing an application of a terminal device of the said network. This method comprises the following steps:
a) the data of an addressing table are read, the said addressing table being stored in a configuration file, the addressing table associating on the one hand ATN addresses of applications of terminal devices, an ATN address comprising a network entity tag (NET) and a point of access to the service of the network layer (NSAP), and on the other hand a UDP service identifier, a UDP service identifier comprising an IP address and a UDP port number;
b) when a protocol data unit of the transport layer (T-PDU) is received originating from the application to be tested, the said protocol data unit of the transport layer comprising a destination ATN address, a UDP datagram is formed and then sent, the UDP datagram encapsulating the said protocol data unit of the transport layer, the UDP datagram furthermore comprising the UDP service identifier associated in a one-to-one manner with the destination ATN address;
c) when a UDP datagram is received, the said UDP datagram comprising a protocol data unit of the transport layer (T-PDU) encapsulated and a UDP service identifier associated in a one-to-one manner with a destination ATN address, the destination ATN address being that of the application to be tested, the protocol data unit (T-PDU) is de-encapsulated and is sent to the application to be tested.

A subject of the invention is also a method for preparing the implementation of a method above, in which:
a) ATN addresses of applications of terminal devices are determined, an ATN address comprising a network entity tag (NET) and a point of access to the service of the network layer (NSAP);
b) a UDP service identifier is associated in a one-to-one manner with each ATN address, a UDP service identifier comprising an IP address and a UDP port number;
c) the data of an addressing table are coded with a determined format, the addressing table comprising a plurality of entries, each entry of the table making it possible to determine the UDP service identifier associated with an IP address and vice versa;
d) the data of the addressing table are written or added to a configuration file.

The invention has the advantage of avoiding the formulation of routing information specific to the ATN network. It furthermore makes it possible to use a single test machine, on which several entities of a virtual ATN network may be simulated.

According to an advantageous embodiment, the method is implemented by software programmed with the STREAMS environment of the C programming language, this software being intended to be executed on a platform of the UNIX type.

### BRIEF DESCRIPTION OF THE DRAWINGS

Other characteristics and advantages of the invention will become apparent on reading the following detailed description presented by way of nonlimiting illustration and given with reference to the appended figures, which represent:

FIG. 1, an exemplary ATN network,

FIG. 2, a communication between two terminal devices in the form of a representation according to the OSI model,

FIG. 3, a STREAMS module,

FIG. 4, an exemplary test machine implementing a method according to the invention,

FIG. 5, STREAMS messages.

### MORE DETAILED DESCRIPTION

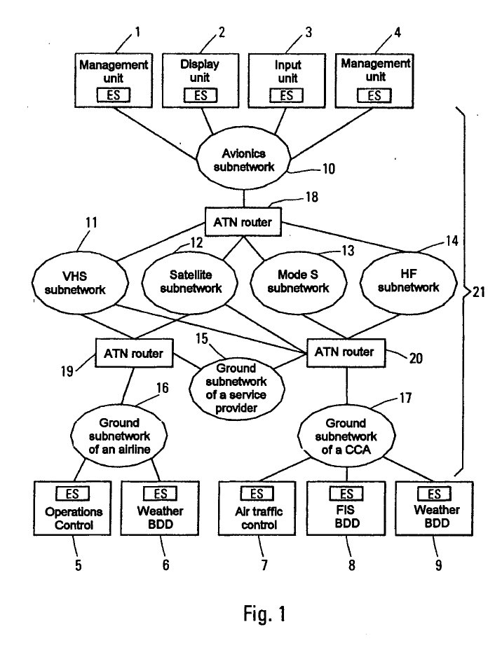

Reference is now made to FIG. 1. An ATN network enables terminal devices of an airline, of an air traffic control service provider (CAA), and of an aircraft to communicate with one another.

The main elements involved in the infrastructure of an ATN network are the subnetworks, the ATN routers (also called intermediate systems) and the terminal devices.

The subnetworks, referenced 10 to 17, form an integral part of the communication network, but are not in themselves ATN devices. A subnetwork is an independent communication network based on a particular technology (for example X.25 “Packet-Switched Network”) used as means for transferring information between ATN devices. A multitude of ground-to-ground or air-to-ground subnetworks make it possible to obtain multiple data paths between the terminal devices.

The ATN routers, referenced 18 to 20 in the figure, have the function of interconnecting varied types of subnetworks. They convey the data packets across these subnetworks according to the class of service requested and according to the present availability of the network infrastructure.

The ATN terminal devices, referenced 1 to 9, provide application services and top protocol layers (OSI model) allowing peer-to-peer communication.

In the example represented in FIG. 1, terminal devices 1, 2, 3, 4 are placed in an aircraft. They comprise management units 1 and 4, a display unit 2, an input unit 3. These various devices are linked by an avionics subnetwork 10, that is to say one carried on board the aircraft. The avionics subnetwork 10 is able to communicate with an ATN router 18. The ATN router 18 is carried on board. The ATN router 18 can exchange data with other ATN routers 19, 20 by way of communication subnetworks 11, 12, 13, 14.

The ATN router 19 is moreover able to communicate by way of a ground subnetwork 16 of an airline with terminal devices of this airline. These terminal devices comprise a control database for the operations 5 and a weather database 6.

The ATN router 20 is for its part able to communicate by way of a ground subnetwork 17 of an air traffic control service provider (CAA) with terminal devices of this service provider. These terminal devices comprise an air traffic control centre 7, a flight information database (FIS standing for “flight information system”) 8, and a weather database 9.

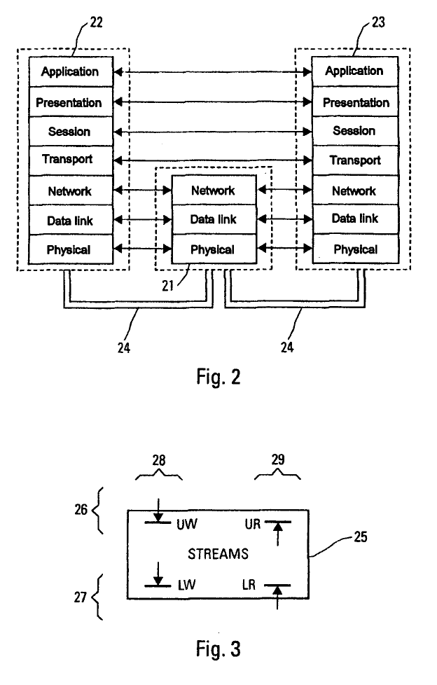

Reference is now made to FIG. 2. The peer-to-peer communication between terminal devices, across the ATN network, assumes the presence of intermediate devices 21 (see also FIG. 1). This communication is represented in diagrammatic form in FIG. 2, this representation using the formalism of the 7-layer OSI model.

Two terminal devices 22 and 23 communicate across the ATN networks. Each is linked to an intermediate device by way of a physical communication channel (radio waves, optical fibre link, coaxial cable, etc.) 24. The intermediate devices 21 make it possible to convey the data from one terminal device to another. In the intermediate devices, the communications layers participating in the conveying of the data are the bottom layers (network, data link, physical) of the OSI model. On the other hand, the peer-to-peer communication involves all the layers of the OSI model.

An exemplary deployment of a programme able to implement the method described will now be described. The programme is a driver written preferably in the C programming language. The driver preferably uses the “STREAMS” mechanisms of the Unix operating system.

In order to use the STREAMS mechanisms, use is made of the programming interface of the same name, available under Unix. This programming interface is described in detail in the reference work entitled “Programmer's Guide STREAMS”, published by Unix System V, version 4.2 (ISBN: 0-13-020660-1).

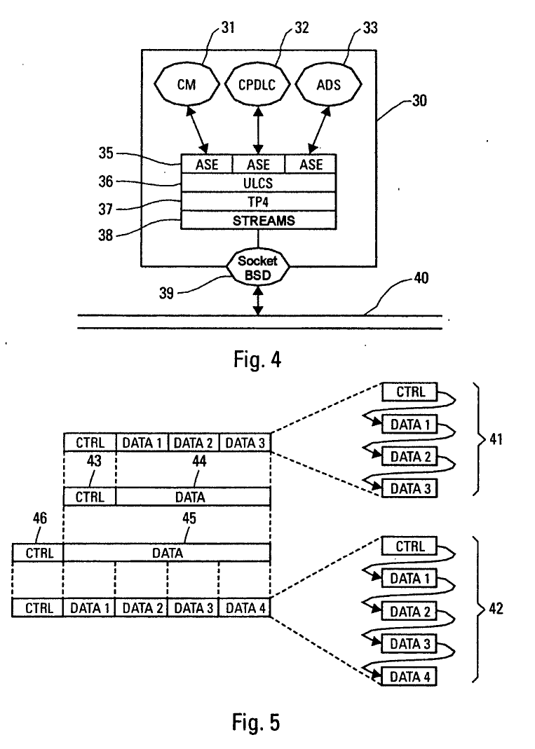

Reference is now made to FIGS. 3 and 4. The driver is intended to be placed in a test machine 30. The applications to be tested are also placed on this test machine. For example, it is possible to test a context management application 31, an application for direct dialogue between a controller and an aircraft pilot 32, or an automatic dependent monitoring application 33. These applications are designated respectively in a conventional manner by the acronyms CM, CPDLC and ADS, emanating from the expressions “Context Management”, “Controller-Pilot Data Link Communication” and “Automatic Dependent Surveillance”.

The test machine furthermore comprises the applications implementing the top protocol layers, that is to say from the transport layer to the application layer in the OSI model. These applications are those intended to be placed in the terminal devices of the ATN network.

The applications implementing the top protocol layers are application service elements 35, the communication services of the top layers 36, and a class 4 transport service 37.

The application service elements are designated in a conventional manner by the acronym ASE standing for “Application Service Element”. These applications are ground or air specific. They make it possible to implement the upper part of the application protocol layer in the OSI model.

The communication services of the top layers are designated in a conventional manner by the acryonym ULCS standing for “Upper-Layer Communication Services”. As far as the transport layer is concerned, this involves a layer implementing the TP4 protocol.

The driver has two interfaces: a top interface 26 and a bottom interface 27. The top interface of the driver is an interface between the transport layers 37 and the network. This interface follows the NPI standard (the acronym standing for “Network Protocol Interface”) in nonconnected mode. A person skilled in the art may consult the document entitled “Network Provider Interface Specification”, from Unix International, OSI Work Group, published on 17 Aug. 1992 under Issue No. 2.0.0. This document describes the interface between the transport and network layers for the STREAMS programming interface.

The bottom interface is a BSD socket interface 39. Stated otherwise, the bottom interface follows the BSD socket interface standard (the acryonym standing for “Berckley Software Distribution”) in nonconnected mode, that is to say using the UDP protocol (the acronym standing for User Datagram Protocol). The BSD socket interface is also known by the name XPG4-UNIX.

The STREAMS programming interface 38 makes it possible to process queues, that is to say structures containing messages. Each interface (top and bottom) has a queue for writing (messages to be sent) and another for reading (messages received and to be processed). These queues are subsequently designated by the references UW, UR, LW and LR. In these references, the letter U represents the top interface, the letter L represents the bottom interface, the letter W represents the write queue and the letter R the read queue.

The queues LW and UR are not used by the driver. Specifically, these queues serve only in the case of congestion. They are therefore not useful in the datagram type protocols in which loss of data is permitted.

For each queue there are two procedures. The first procedure makes it possible to position a message in the queue. This procedure is designated by the expression “put procedure”. The second procedure makes it possible to process a non-urgent message emanating from the queue. This second procedure is designated by the expression “service procedure”.

A possible implementation of the service procedure associated with the queue UW, designated by the expression “UW service procedure”, is now described.

This procedure aims to process a message received (STREAMS terminology), also called a primitive in reference to the OSI model. In order to comply with the NPI standard in nonconnected mode, a message N_BIND_ACK is returned if the message received from the upper layer is N_BIND_REQ, and a message N_UNBIND_ACK is returned if the message received from the upper layer is N_UNBIND_REQ.

If the message received is a request for unitary data coming from the transport layer, this message being designated in a conventional manner by the symbol N_UNITDATA_REQ, the data of the transport layer are encapsulated in a UDP datagram.

Reference is now made to FIG. 5 in which a message N_UNITDATA_REQ is represented. In this implementation, the message 14 is a STREAMS message. In this regard it comprises a control field 43 on the one hand, and a data field 44 on the other hand. The control field is designated in a conventional manner by the symbol CTRL, and the data field by the symbol DATA.

The message 14 is additionally a protocol data unit (T-PDU) originating from the transport layer 37 (see FIG. 4). This protocol data unit originates from one of the applications to be tested 31, 32, 33. The protocol data unit contains the destination ATN address, that is to say the ATN address of the recipient terminal device.

The destination ATN address is included in the control field 43 of the message 41. The UDP service identifier associated in a one-to-one manner with the destination ATN address is determined on the basis of this ATN address.

A UDP datagram is formed, the UDP datagram encapsulating the said protocol data unit of the transport layer. The UDP datagram is also a STREAMS message. This message 42 has the same structure as the message received 41, in the sense that it comprises a control field 46 and a data field 45. The encapsulation consists in placing the control fields and data fields of the message received in the data field 45 of the UDP datagram.

The UDP datagram comprises a UDP service identifier determined on the basis of the destination ATN address. The service identifier, that is to say the IP address and the UDP port number, is placed in the control field 46 of the datagram.

Once formed, the UDP datagram is sent. This send is carried out by a call “Sendmsg( )” of the BSD socket interface. This socket interface is represented under reference 39 in FIG. 4.

The method implemented during the sending of data by the application to be tested has thus been described. The method implemented during the receiving of data by the application to be tested is now described.

Reception may be implemented by an inverse method (de-encapsulation), by deploying the service procedure associated with the queue LR, designated by the expression “LR service procedure”.

According to another implementation, use is made of a procedure for polling the local UDP port (socket) which is open during the initialization of the STREAMS module. This polling procedure replaces the deployment of the service procedure of the queue LR.

The polling procedure reads the local UDP socket. For this purpose use is made of the instruction “Recvmsg( )” which makes it possible to obtain a file descriptor.

If a message is present, this message originates from the BSD socket interface. This message is then a UDP datagram constructed by encapsulating data sent by another ATN terminal device.

The UDP datagram comprises a protocol data unit of the transport layer (T-PDU) encapsulated, that is to say placed in the data field of the message. The control field of the message for its part comprises a UDP service identifier. This service identifier is associated in a one-to-one manner with a destination ATN address. If the associated ATN address is that of the application (or of one of the applications) to be tested, the protocol data unit (T-PDU) is de-encapsulated and is sent to the application to be tested.

In order to carry out this send, the polling procedure uses a call “PutNexto” which carries out a call “Puto” on the queue LR of the underlying module, the STREAMS module of the driver in this instance. The parameter of the “PutNexto” procedure is the de-encapsulated message. This message is a message of N_UNITDATA_IND type.

An exemplary deployment of a procedure for initializing the driver is now described. This initialization procedure is executed at the start of the simulation. The simulation programme may be called with a Unix command line, taking as first argument an ATN address of the test machine (N-SAP) and as second argument the local UDP port number of the test machine.

The initialization procedure makes a call to open a BSD socket, with the command “Socket( )” in the C language. The call to open a BSD socket returns an integer, corresponding to a file descriptor.

Thereafter, the initialization procedure specifies the file descriptor with the command “Bind( )” in the C language.

These two calls may be represented by the following lines of code:
fd=Socket(AT_INET,SOCK_DGRAM)
Bind (fd,port)
in which:
   fd denotes the file descriptor,
   AF_INET denotes the Internet domain,
   SOCK_DGRAM denotes the datagram protocol (UDP),
   Port denotes the port number provided.

1. Method of simulating an ATN network intended for testing an application of a terminal device of the said network, in which:
a) the data of an addressing table are read, the said addressing table being stored in a configuration file, the addressing table associating on the one hand ATN addresses of applications of terminal devices, an ATN address comprising a network entity tag (NET) and a point of access to the service of the network layer (NSAP), and on the other hand a UDP service identifier, a UDP service identifier comprising an IP address and a UDP port number;
b) when a protocol data unit of the transport layer (T-PDU) is received originating from the application to be tested, the said protocol data unit of the transport layer comprising a destination ATN address, a UDP datagram is formed and then sent, the UDP datagram encapsulating the said protocol data unit of the transport layer, the UDP datagram furthermore comprising the UDP service identifier associated in a one-to-one manner with the destination ATN address;
c) when a UDP datagram is received, the said UDP datagram comprising a protocol data unit of the transport layer (T-PDU) encapsulated and a UDP service identifier associated in a one-to-one manner with a destination ATN address, the destination ATN address being that of the application to be tested, the protocol data unit (T-PDU) is de-encapsulated and is sent to the application to be tested.

2. Method for preparing the implementation of a method of simulation according to claim 1, in which:
a) ATN addresses of applications of terminal devices are determined, an ATN address comprising a network entity tag (NET) and a point of access to the service of the network layer (NSAP);
b) a UDP service identifier is associated in a one-to-one manner with each ATN address, a UDP service identifier comprising an IP address and a UDP port number;
c) the data of an addressing table are coded with a determined format, the addressing table comprising a plurality of entries, each entry of the table making it possible to determine the UDP service identifier associated with an IP address and vice versa;
d) the data of the addressing table are written or added to a configuration file.
